(19) United States
(12) Patent Application Publication
(10) Pub. No.: US 2019/0371087 A1
(43) Pub. Date: Dec. 5, 2019

(54) VEHICLE DEVICE EQUIPPED WITH ARTIFICIAL INTELLIGENCE, METHODS FOR COLLECTING LEARNING DATA AND SYSTEM FOR IMPROVING PERFORMANCE OF ARTIFICIAL INTELLIGENCE

(71) Applicant: LG ELECTRONICS INC., Seoul (KR)

(72) Inventors: Wonho SHIN, Seoul (KR); Jichan MAENG, Seoul (KR)

(73) Assignee: LG ELECTRONICS INC., Seoul (KR)

(21) Appl. No.: 16/542,109

(22) Filed: Aug. 15, 2019

(30) Foreign Application Priority Data
Jun. 10, 2019 (KR) 10-2019-0068245

(51) Int. Cl. G07C 5/08; G06N 3/08; G08G 1/01

(52) U.S. Cl. CPC G07C 5/085; G07C 5/0808; G08G 1/0133; G06N 3/08

(57) ABSTRACT

An embodiment of the present invention relates to a method for collecting learning data using a vehicle terminal equipped with artificial intelligence, the method includes establishing a communication connection with a server of 5G communication networks through a communication unit of the vehicle terminal, obtaining a driving image of the vehicle through an image obtaining unit of the vehicle terminal, inputting the obtained driving image into a neural network model trained to determine whether an event has occurred, and determining whether an event indicating an abnormal operation of the vehicle occurs from the obtained image through an output of the neural network model, extracting an event frame at the time of the event happened in the driving image; and transmitting the extracted event frame to the server.

### CROSS-REFERENCE TO RELATED APPLICATION

Pursuant to 35 U.S.C. § 119(a), this application claims the benefit of earlier filing date and right of priority to Korean Patent Application No. 10-2019-0068245, filed on Jun. 10, 2019, the contents of which are hereby incorporated by reference herein in its entirety.

### BACKGROUND OF THE INVENTION

### Field of the Invention

Embodiments of the invention relate to a system for obtaining a frame of corresponding mage by accurately detecting an event occurring during operation of a vehicle based on artificial intelligence, and improving performance of the artificial intelligence using the obtained frame as learning data.

### Description of the Related Art

A black box is a device that continuously obtains and stores images during operation of a vehicle through a camera installed close to the front/rear glass of the vehicle, and operates to store a certain period of images in a memory when an event such as an accident occurs.

The images taken in the black box are used to distinguish between right and wrong in the accident, as data on criminal act, or in combination with business models.

Incidentally, since the black box so far determines the presence or absence of the accident by the operation of sensors such as a shock sensor or a pressure sensor, there is a limit in accurately determining a traffic accident or the like.

### SUMMARY OF THE INVENTION

The present invention has been made in view of this technical background, when an event such as an accident occurs, a vehicle terminal such as a black box installed in a vehicle transmits images of the corresponding event to a server and uses it as learning data for improving performance of artificial intelligence.

Further, the present invention trains artificial intelligence using images obtained from a large number of vehicles, and upgrades the performance of artificial intelligence installed in each vehicle.

An embodiment of the present invention relates to a method for collecting learning data using a vehicle terminal equipped with artificial intelligence, the method includes establishing a communication connection with a server of 5G communication networks through a communication unit of the vehicle terminal, obtaining a driving image of the vehicle through an image obtaining unit of the vehicle terminal, inputting the obtained driving image into a neural network model trained to determine whether an event has occurred, and determining whether an event indicating an abnormal operation of the vehicle occurs from the obtained image through an output of the neural network model, extracting an event frame at the time of the event happened in the driving image; and transmitting the extracted event frame to the server.

The method may further include obtaining sensing information through a sensing unit, wherein the step of determining whether the event occurs may be performed by combining the frame and the sensing information, and the sensing information may include at least one of shock detection data, distance data between the vehicle and another adjacent vehicle, acoustic data obtained during driving, speed data of the vehicle, position data of a driver driving the vehicle, and operation pattern data of the vehicle.

The vehicle terminal may be at least one of a black box, an on-board diagnostics (OBD), and a navigation.

The method may further include displaying a message confirming whether to agree to transmit the event frame to the server on a display unit of the vehicle terminal when the vehicle terminal is executed.

The event may include at least one of a traffic accident of the vehicle, a similar traffic accident similar to a traffic accident, and a violation of traffic regulations.

The method may further include receiving an update file from the server and updating the neural network model to a latest version in accordance with the update file.

Another embodiment of the present invention relates to a method for updating a neural network model in a server connected to a plurality of vehicle terminals having the neural network model through 5G communication networks, the method includes establishing a communication connection with each of the plurality of vehicle terminals through the 5G communication networks, receiving an event frame from the each of the vehicle terminals, updating the neural network model by training the neural network model to determine whether an event is occurred using the received event frame as learning data, and generating an update file for updating the neural network model installed in the vehicle terminal to the updated neural network model installed in the server, and transmitting the update file to the each of the vehicle terminals.

The method may further include performing an initial access procedure with the vehicle terminal by periodically transmitting a synchronization signal block (SSB), performing a random access procedure with the vehicle terminal, and transmitting an uplink (UL) grant to the vehicle terminal for scheduling message transmission.

The performing the random access procedure may further include receiving a PRACH preamble from the vehicle terminal and transmitting a response to the PRACH preamble to the vehicle terminal.

The method may further include performing a downlink beam management (DL BM) procedure using the SSB, wherein the performing the DL BM procedure may further include transmitting a CSI-ResourceConfig IE including a CSI-SSB-ResourceSetList to the vehicle terminal, transmitting a signal on SSB resources to the vehicle terminal, and receiving a best SSBRI and corresponding RSRP from the vehicle terminal.

The method may further include transmitting establishing information of a reference signal related to beam failure detection to the vehicle terminal and receiving a PRACH preamble requesting beam failure recovery from the vehicle terminal.

In the third embodiment of the present invention, it is possible to provide a vehicle terminal equipped with artificial intelligence including an image obtaining unit configured to obtain a driving image of a vehicle, an AI processing unit, including a neural network model trained to determine whether an event has occurred, configured to input the obtained driving image in the image obtaining unit into the neural network model, and determine whether an event indicating an abnormal operation of the vehicle occurs from the obtained image through an output of the neural network model, and a communication unit configured to establish a communication connection with a server through 5G communication networks, and transmit an event frame to the server.

The fourth embodiment of the present invention relates to a system including a plurality of vehicle terminals connected to a server through the server and 5G communication networks, including each of the plurality of vehicle terminals includes an image obtaining unit configured to obtain a driving image of a vehicle, an AI processing unit, including a neural network model trained to determine whether an event has occurred, configured to input the obtained driving image in the image obtaining unit into the neural network model, and determine whether an event indicating an abnormal operation of the vehicle occurs from the obtained image through an output of the neural network model, and a communication unit configured to establish a communication connection with the server through the 5G communication networks, and transmit an event frame to the server, and the server includes an update module, including the neural network model, configured to train the neural network model by using the event frame transmitted from the vehicle terminal as learning data, and generate an update file that updates the neural network model included in the AI processing unit to a latest version.

According to an embodiment of the present invention, since the present invention is configured to train artificial intelligence by receiving learning data for improving accident awareness based on the artificial intelligence from a plurality of vehicle terminals connected to the server, the data necessary for learning can be obtained easily.

Since the artificial intelligence is trained and the performance is updated based on the accident image obtained through a large number of vehicle terminals connected through a network, it is possible to determine the presence or absence of the traffic accident more accurately than before.

Since the performance of the artificial intelligence is constantly updated, it is possible to reduce the memory burden by reducing the noise image stored due to the malfunction of the sensor even though it is not an accident previously.

### BRIEF DESCRIPTION OF THE DRAWINGS

FIG. 1 illustrates a block diagram of a wireless communication system to which methods proposed in the present disclosure may be applied.

FIG. 2 is a diagram illustrating an example of a method for transmitting/receiving 3GPP signals.

FIG. 3 is a diagram illustrating a system configuration for embodiments of the present invention implemented based on the above-described 5G communication technology.

FIG. 4 is a diagram showing a functional configuration of a vehicle terminal.

FIG. 5 is a diagram for explaining a configuration of a sensing unit.

FIG. 6 is a diagram for explaining a driving method of a vehicle terminal.

FIG. 7 is a diagram illustrating signal changes of driving images along a time axis.

FIG. 8 is a diagram for explaining a process of updating an AI processing unit.

### DETAILED DESCRIPTION OF THE EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through E.

### A. Example of Block Diagram of UE and 5G Network

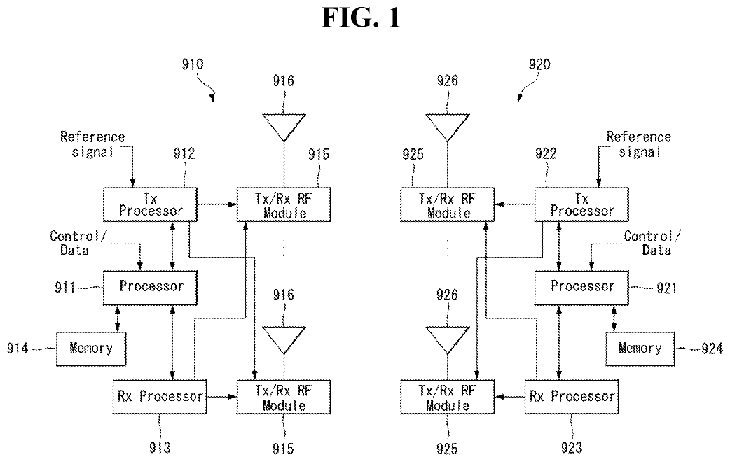

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

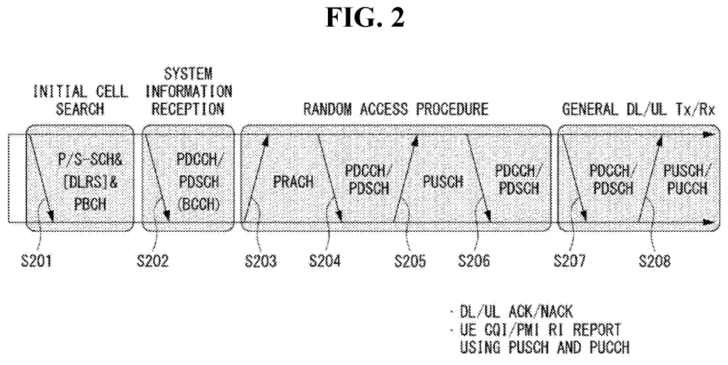

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

The above-described 5G communication technology can be combined with methods proposed in the present invention which will be described later and applied or can complement the methods proposed in the present invention to make technical features of the methods concrete and clear.

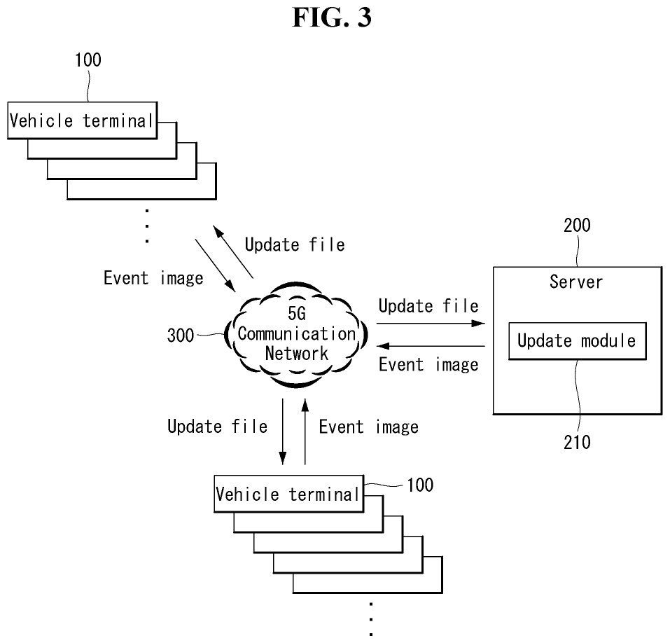

FIG. 3 is a diagram illustrating a system configuration for embodiments of the present invention implemented based on the above-described 5G communication technology.

A system according to an embodiment of the present invention may include a vehicle terminal 100 equipped with a vehicle for producing a driving image of the vehicle, a 5G communication network 300 that enables 5G communication between objects based on the above-described 5G communication technology, and a server 200 connected to the vehicle terminal 100 through the 5G communication network 300.

Here, the server 200 may be 1: n connected to the vehicle terminal 100 through the 5G communication network 300, instead of 1:1. That is, the server 200 may be connected to a large number of the vehicle terminals 100 through the 5G communication network 300, which is a high-speed data network, and configured to transmit and receive data from the vehicle terminal 100.

The vehicle terminal 100 may be implemented as a black box, an on-board diagnostics (OBD), a navigation, or the like as an example.

The vehicle terminal 100 may photograph the driving image from cameras installed on front and back or front, back, right, and left sides of the vehicle and store it in a memory. If necessary, the photographed image may be recorded and stored as operation data such as information obtained by sensors, GPS information, and the like.

In addition, the vehicle terminal 100 may store a plurality of measurement information such as carbon dioxide emission amount information and driving distance information of the vehicle as the vehicle operation data, and in addition, the vehicle terminal 100 may store a plurality of navigation information such as route data, speed data, destination data, and regulation violation data such as whether the center line has been violated, the specified speed has been complied with, or a signal has been violated in accordance with the driving of the vehicle as the vehicle driving data.

In addition, the vehicle terminal 100 may be further configured to include an AI processing unit that determines whether an event has occurred from the driving image obtained during the driving of the vehicle using the a neural network model trained to determine whether an event is occurred.

The neural network model constituting the AI processing unit may be shared with a plurality of other vehicle terminals 100 connected through the 5G communication network, and the server 200, or may be separately installed on each vehicle terminal. If the neural network model is installed for each vehicle terminal, an update file may be a file that constitutes the AI processing unit 180 and updates the neural network model stored in the memory of the vehicle terminal 100 to the latest version of the neural network model.

The server 200 may include an update module 210. The update module 210 may operate to receive event frames from a large number of vehicle terminals 100 connected through the 5G communication network 300 and use the received event frames as learning data to train the neural network model to improve the performance of the AI processing unit.

In addition, the server 200 may generate the update file for updating the AI processing unit installed in the vehicle terminal 100 to the latest version, and distribute it to the vehicle terminal 100. Accordingly, the artificial intelligence performance of the AI processing unit may be improved through the deep learning technique, and may more accurately determine events occurring during the driving of the vehicle.

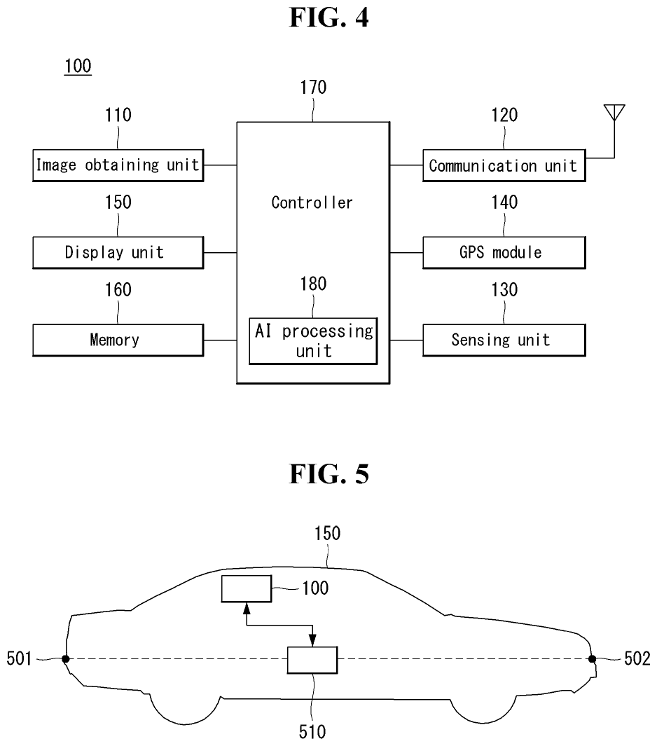

Hereinafter, with reference to FIG. 4 and FIG. 5, a vehicle terminal 100 according to an embodiment of the present invention will be described in more detail.

Referring to these drawings, the vehicle terminal 100 according to an embodiment of the present invention may be configured to include an image obtaining unit 110, a communication unit 120, a sensing unit 130, a GPS module 140, a display unit 160, a memory 160, and a controller 170 including an AI processing unit 180.

The controller 170 installs a program for managing overall operation of the vehicle terminal 100 and transmits event frames collected by the vehicle terminal 100 to the server 200.

The image obtaining unit 110 operates to obtain images during operation of the vehicle, and may be configured to include a physical configuration such as a camera.

The AI processing unit 180 may determine whether an event is occurred from a driving image that is composed of a plurality of frames that are executed together with the operation of the image obtaining unit 110 and input through the image obtaining unit 110, when the event occurs, and operate to extract a corresponding frame (hereinafter, referred to as an event frame) at the time of the event happened from the driving image. The AI processing unit 180 may operate to determine whether the event occurs based on the installed neural network model. Here, the event may include at least one of a traffic accident of the vehicle, a similar traffic accident that is not a traffic accident but is considered similar to an accident, and a violation of traffic regulations. Here, the traffic accident may mean an accident involving an unintended crash, such as people and vehicles, vehicles and vehicles, vehicles and motorcycles, vehicles and objects. Further, the neural network model installed on the AI processing unit 180 may be updated to the latest version based on the update file transmitted from the server, and the performance thereof may be improved.

The AI processing unit 180 may be configured to include a plurality of modules capable of performing AI processing.

The AI processing may include all operations for data execution processing for event detection. For example, the AI processing unit 1800 may perform processing/determination, and control signal generation operations by AI processing sensing data obtained by the sensing unit 130 or obtained data.

The AI processing unit 180 is capable of execution processing through a neural network using a program stored in the memory as a computing unit capable of execution processing through the neural network. In particular, the AI processing unit 180 may perform execution processing using the neural network to recognize image analysis data.

Here, the neural network may be designed to simulate a human brain structure on a computer, and may include a plurality of weighted network nodes that simulate a neuron of a human neural network. A plurality of network modes may transmit and receive data in accordance with the respective connection relationships so that the neuron simulates synaptic activity of the neuron transmitting and receiving signals through synapse. Here, the neural network may include a deep learning model developed in the neural network model. In the deep learning model, the plurality of network nodes are located on different layers and may transmit and receive data in accordance with a convolution connection relationship. Examples of the neural network models may include various deep-running techniques such as deep neural networks (DNN), convolutional deep neural networks (CNN), recurrent boltzmann machine (RNN), restricted boltzmann machine (RBM), deep belief networks (DBN), and deep Q-Network.

On the other hand, the AI processing unit 180 performing the functions as described above may be a general-purpose processor (e.g., a CPU), but may be an AI-dedicated processor (e.g., a GPU) for artificial intelligence computation.

The communication unit 120 may be configured to enable data communication between the vehicle terminal 100 and the server 200 based on the 5G communication technology described with reference to FIGS. 1 and 2. Accordingly, the data transmitted and received between the two devices may be transmitted and received at a very high speed through the 5G communication network 300.

The display unit 150 may provide a user input unit such as a user interface to allow the vehicle terminal 100 to transmit and receive data required for operation, and may be operable to display a message to obtain specific information from a user if necessary. In addition, the driving image obtained through the image obtaining unit 110 may be viewed through the display unit 150 in real time.

The memory 160 may store a program defining a series of operations required for the vehicle terminal 100 to operate, an image obtained through the image obtaining unit 110, data such as an event frame, and neural network models.

On the other hand, as described with reference to FIG. 5, a vehicle 500 may be configured to include a variety of sensors so as to obtain necessary information during driving, such as a shock sensor 501 for detecting a shock, a distance sensor 502 for measuring a distance between the vehicle 500 and another object, and sensing information sensed by each sensor may be configured to be transmitted to a vehicle electronic control unit (ECU) 510.

In the present invention, the sensing unit 130 may be composed of sensors installed on the vehicle 500 as described above, or may be composed of additional installed sensors alone or a combination of the sensors installed on the vehicle and newly added sensors when necessary.

The sensing information obtained through the sensing unit 130 may be transmitted to the AI processing unit 180 and used to determine whether an event has occurred, and may be configured to further improve its performance.

Here, the sensing information may include at least one of shock detection data, distance data between the vehicle and another vehicle adjacent to the vehicle, acoustic data obtained during driving, speed data of the vehicle, position data of a driver who drives the vehicle, and operation pattern data of the vehicle, or a combination thereof.

The AI processing unit 180 may more accurately determine whether an event occurs through the sensing information and AI image processing. For example, in the event of a vehicle collision, since a high-pitched sound, such as a high-pitched collision sound or a tire's friction sound, occurs instantaneously than usual, this may be combined with image analysis results to make more accurate decisions. In addition, since the driver shows a sudden movement in a vehicle accident, the performance of artificial intelligence may be supplementally improved if the position data is out of the normal range of movement.

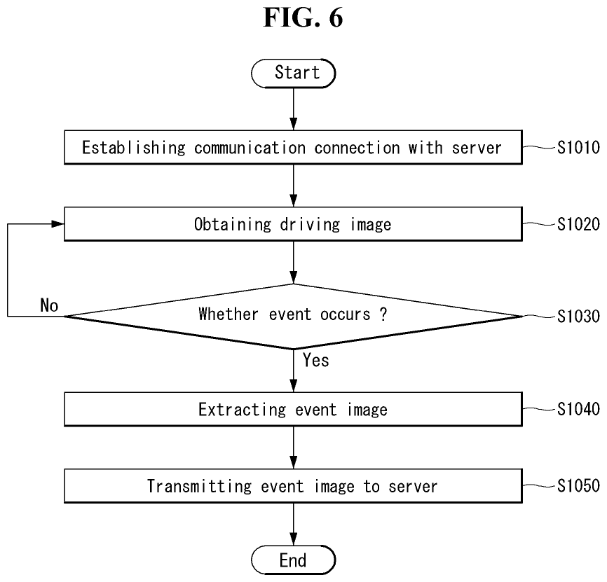

Hereinafter, an operation method of the vehicle terminal described above with reference to FIG. 6 will be described.

In step S1010, the communication unit 120 connects a session so as to enable data communication with the server 200 under the control of the controller 170. This substitutes the above description through FIG. 1 and FIG. 2. In a preferred form, the communication unit 120 may operate to detect that the communication unit 120 is started and connect the session according to the startup, and to detect that the startup is turned off to close the session and to reduce the battery consumption of the vehicle.

In addition, when a user terminal is initially started, the controller 170 may display a message 1001 illustrated in FIG. 39 on the display unit 150, and may further advance a step of obtaining user's approval beforehand. The user may approve or disapprove that an event frame is transmitted to the server by touching a button included in the message 1001.

When a response of the message is approval, the controller 170 may control the communication unit 120 to operate so that the event frame is transmitted to the server 200, and when the response of the message is disapproval, the controller 170 may control the communication unit 120 to store the event frame in the memory 160 instead of controlling the event frame not to be transmitted to the server 202.

In step S1020, after the communication connection is established, the controller 170 may operate to control the image obtaining unit 110 to obtain the driving image of the vehicle. At this step, when the vehicle starts to move, the controller 170 may control the operation of the image obtaining unit 110 to record the driving image, and when the vehicle stops, the controller 170 may control the operation of the image obtaining unit 110 to prevent the driving image from being recorded.

In step S1030, when the driving image is recorded, the AI processing unit 180 determines in real time whether an event occurs. Here, the determination of the event is based on artificial intelligence, and the sensing information may be used for more accurate determination.

The driving image obtained by the image obtaining unit 110, the obtained driving image, is input to a neural network model trained to determine whether an event has occurred, and it is determined whether the event occurs through the output of the neural network model, the event may include at least one of driving of the vehicle causing a traffic accident, driving of the vehicle similar to a traffic accident, and driving of the vehicle in a violation of traffic regulations.

The AI processing unit 180 may classify events based on the following learning model.

If the data classification p (O|Θ) is greater than Thr2, it can be determined as a traffic accident, if the data classification p (O|Θ) is greater than Thr1 and less than Thr2, it can be determined as a similar traffic accident, and if the data classification p (O|Θ) is less than Thr1, it can be determined that it is not a traffic accident. Here, Θ denotes a neural network model generated after learning.

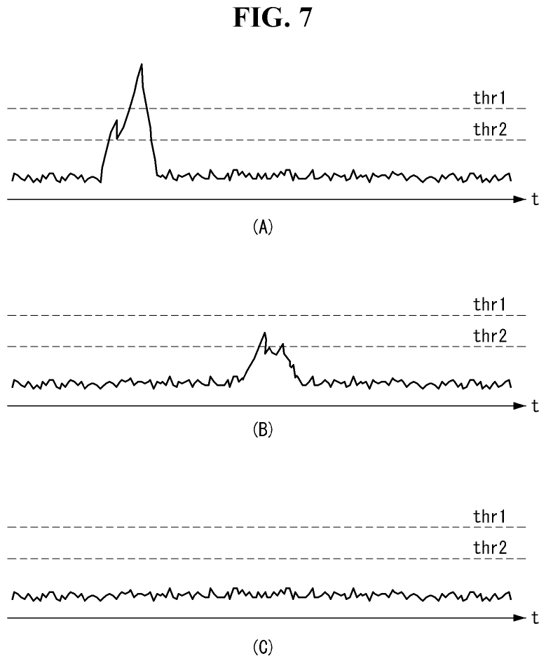

This will be described in more detail with reference to FIG. 7. FIG. 7 shows signal changes of driving images along a time axis.

Based on the trained neural network model Θ, the AI processing unit 180 analyzes the driving image along the time axis to determine whether a signal of the driving image is higher than a first threshold Thr1 or a second threshold Thr2, when the signal becomes higher than the second threshold Thr2, the AI processing unit 180 recognizes that the event has occurred. The signal (A) in FIG. 7 may mean that a traffic accident has occurred, the signal (B) in FIG. 7 may mean that a similar traffic accident has occurred, and the signal (C) in FIG. 7 may mean that no traffic accident will occur.

If it is determined in step S1030 that an event has occurred, the AI processing unit 180 may extract the instant as an event frame (S1040).

In the next step S1050, the extracted event frame is transmitted to the server 20 in accordance with whether the user agrees or not, or when the user does not agree, the controller 170 may operate to store the extracted event frame from the memory 160.

Through the operation of the vehicle terminal as described above, learning data necessary for training the neural network model is collected, the collected learning data is transmitted to the server and may be used to train the neural network model.

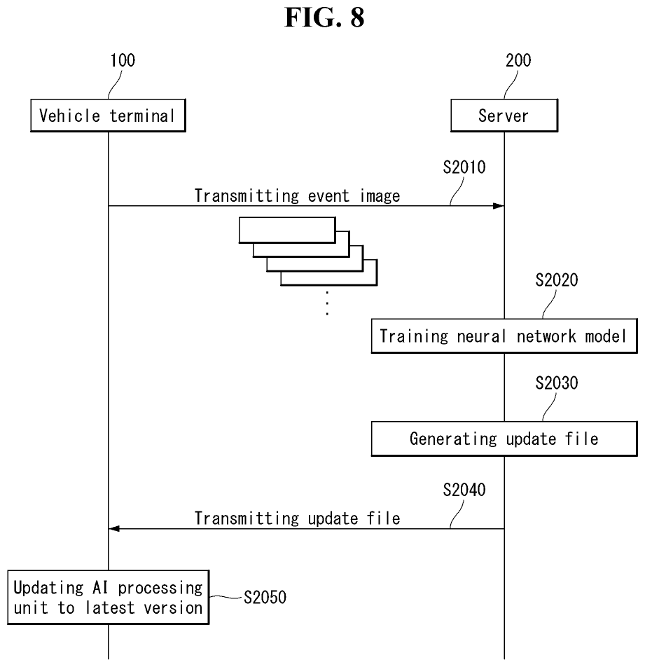

Hereinafter, an updating method for enhancing a performance of artificial intelligence equipped with a vehicle will be described with reference to FIG. 8.

As is known, artificial intelligence may improve its performance in accordance with learning of a neural network model, and similar learning data is required for deep learning. In an embodiment of the present invention, the performance of artificial intelligence may be improved by training the neural network model using an event frame as learning data.

In step S2010, a plurality of vehicle terminals 100 connected through the 5G communication network 300 operate to transmit the event frame to the server 300 when an event occurs. Here, the event includes a traffic accident of the vehicle or a similar traffic accident similar to a traffic accident.

In step S2020, the update module 210 of the server 200 receiving the event frame, using the obtained learning data, trains the neural network model to have a determination criterion about how to classify predetermined data. At this time, the update module 210 may train the neural network model through supervised learning using at least some of the learning data as the determination criterion. Alternatively, the update module 210 may train the neural network model through unsupervised learning to find the determination criterion by self-training using the learning data without supervision. In addition, the update module 210 may train the neural network model through reinforcement learning using feedback on whether a result of situation determination in accordance with learning is correct. In addition, the update module 210 may train the neural network model using a learning algorithm that includes error back-propagation or gradient descent.

In step S2030, when the neural network model is trained, the update module 210 may generate an update file that allows the AI processing unit 180 to use the latest version with respect to the trained neural network model. Here, the update file may be a file that updates the neural network model installed in each vehicle to the latest version same as the neural network model trained in the server.

In steps S2040 and S2050, the update file is transmitted to all the vehicle terminals 100 connected to the server 200 through the 5G communication network 300, the AI processing unit 180 is updated in accordance with the update file received at the vehicle terminal, as a result, the performance of artificial intelligence can be improved.

The above detailed description should not be construed in all aspects as limiting and should be considered illustrative. The scope of the present invention should be determined by rational interpretation of the appended claims, and all variations within the scope of equivalents of the present invention are included in the scope of the present invention.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for collecting learning data using a vehicle terminal equipped with artificial intelligence, comprising:
establishing a communication connection with a server of 5G communication networks through a communication unit of the vehicle terminal;
obtaining a driving image of the vehicle through an image obtaining unit of the vehicle terminal;
inputting the obtained driving image into a neural network model trained to determine whether an event has occurred, and determining whether an event indicating an abnormal operation of the vehicle occurs from the obtained image through an output of the neural network model;
extracting an event frame at the time of the event happened in the driving image; and
transmitting the extracted event frame to the server.

2. The method of claim 1, further comprising:
obtaining sensing information through a sensing unit,
wherein the step of determining whether the event occurs is performed by combining the frame and the sensing information, and
the sensing information includes at least one of shock detection data, distance data between the vehicle and another adjacent vehicle, acoustic data obtained during driving, speed data of the vehicle, position data of a driver driving the vehicle, and operation pattern data of the vehicle.

3. The method of claim 1, wherein the vehicle terminal is at least one of a black box, an on-board diagnostics (OBD), and a navigation.

4. The method of claim 1, further comprising:
displaying a message confirming whether to agree to transmit the event frame to the server on a display unit of the vehicle terminal when the vehicle terminal is executed.

5. The method of claim 1, wherein the event includes at least one of a traffic accident of the vehicle, a similar traffic accident similar to a traffic accident, and a violation of traffic regulations.

6. The method of claim 1, further comprising:
receiving an update file from the server; and
updating the neural network model to a latest version in accordance with the update file.

7. A method for updating a neural network model in a server connected to a plurality of vehicle terminals having the neural network model through 5G communication networks, the method for updating the neural network model installed in a vehicle terminal, comprising:
establishing a communication connection with each of the plurality of vehicle terminals through the 5G communication networks;
receiving an event frame from the each of the vehicle terminals;
updating the neural network model by training the neural network model to determine whether an event is occurred using the received event frame as learning data; and
generating an update file for updating the neural network model installed in the vehicle terminal to the updated neural network model installed in the server, and transmitting the update file to the each of the vehicle terminals.

8. The method of claim 7, wherein the event includes at least one of a traffic accident of the vehicle, a similar traffic accident similar to a traffic accident, and a violation of traffic regulations.

9. The method of claim 7, further comprising:
performing an initial access procedure with the vehicle terminal by periodically transmitting a synchronization signal block (SSB);
performing a random access procedure with the vehicle terminal; and
transmitting an uplink (UL) grant to the vehicle terminal for scheduling message transmission.

10. The method of claim 9, wherein the performing the random access procedure further includes:
receiving a PRACH preamble from the vehicle terminal; and
transmitting a response to the PRACH preamble to the vehicle terminal.

11. The method of claim 9, further comprising:
performing a downlink beam management (DL BM) procedure using the SSB,
wherein the performing the DL BM procedure further includes:
transmitting a CSI-ResourceConfig IE including a CSI-SSB-ResourceSetList to the vehicle terminal;
transmitting a signal on SSB resources to the vehicle terminal; and
receiving a best SSBRI and corresponding RSRP from the vehicle terminal.

12. The method of claim 9, further comprising:
transmitting establishing information of a reference signal related to beam failure detection to the vehicle terminal; and
receiving a PRACH preamble requesting beam failure recovery from the vehicle terminal.

13. A vehicle terminal equipped with artificial intelligence, comprising:
an image obtaining unit configured to obtain a driving image of a vehicle;
an AI processing unit, including a neural network model trained to determine whether an event has occurred, configured to input the obtained driving image in the image obtaining unit into the neural network model, and determine whether an event indicating an abnormal operation of the vehicle occurs from the obtained image through an output of the neural network model; and
a communication unit configured to establish a communication connection with a server through 5G communication networks, and transmit an event frame to the server.

14. The vehicle terminal of claim 13, further comprising:
a sensing unit configured to obtain sensing information,
wherein the determining whether the event occurs is performed based on the frame and the sensing information, and
the sensing information includes at least one of shock detection data, distance data between the vehicle and another adjacent vehicle, acoustic data obtained during driving, speed data of the vehicle, position data of a driver driving the vehicle, and operation pattern data of the vehicle.

15. The vehicle terminal of claim 13, wherein the vehicle terminal is at least one of a black box, an on-board diagnostics (OBD), and a navigation.

16. The vehicle terminal of claim 13, further comprising:
a display unit configured to display a message confirming whether to agree to transmit the event frame to the server when the vehicle terminal is executed.

17. The vehicle terminal of claim 13, wherein the event includes at least one of a traffic accident of the vehicle, a similar traffic accident similar to a traffic accident, and a violation of traffic regulations.

18. The vehicle terminal of claim 13, wherein the AI processing unit, when receiving an update file from the server, updates the neural network model to a latest version depending on the update file.

19. A system including a plurality of vehicle terminals connected to a server through the server and 5G communication networks, comprising:
each of the plurality of vehicle terminals includes:
an image obtaining unit configured to obtain a driving image of a vehicle;
an AI processing unit, including a neural network model trained to determine whether an event has occurred, configured to input the obtained driving image in the image obtaining unit into the neural network model, and determine whether an event indicating an abnormal operation of the vehicle occurs from the obtained image through an output of the neural network model; and
a communication unit configured to establish a communication connection with the server through the 5G communication networks, and transmit an event frame to the server, and
the server includes:
an update module, including the neural network model, configured to train the neural network model by using the event frame transmitted from the vehicle terminal as learning data, and generate an update file that updates the neural network model included in the AI processing unit to a latest version.
